(19) United States
(12) Patent Application Publication
(10) Pub. No.: US 2025/0367647 A1
(43) Pub. Date: Dec. 4, 2025

(54) SYNTHESIS OF A CATALYST COMPRISING A HIGH-PURITY NU-86 ZEOLITE AND IRON FOR THE CONVERSON OF NOX AND N2O

(71) Applicant: IFP Energies nouvelles, RUEIL-MALMAISON (FR)

(72) Inventors: Monique PRIGENT, RUEIL-MALMAISON CEDEX (FR); Bogdan HARBUZARU, RUEIL-MALMAISON CEDEX (FR); David BERTHOUT, RUEIL-MALMAISON CEDEX (FR); Raquel MARTINEZ FRANCO, RUEIL-MALMAISON CEDEX (FR)

(21) Appl. No.: 18/874,929

(22) PCT Filed: Jun. 9, 2023
(86) PCT No.: PCT/EP2023/065485

§ 371 Date: Dec. 13, 2024

(30) Foreign Application Priority Data
Jun. 17, 2022 (FR) FR2205939

(51) Int. Cl. B01J 29/76; B01D 53/86; B01J 35/30; B01J 35/57; B01J 37/00; B01J 37/03; B01J 37/04; B01J 37/10; B01J 37/30; C01B 39/48

(52) U.S. Cl. CPC B01J 29/76; B01D 53/8628; B01J 35/394; B01J 35/57; B01J 37/0018; B01J 37/036; B01J 37/04; B01J 37/10; B01J 37/30; C01B 39/48; B01D 2255/20738; B01D 2255/50; B01D 2255/9155; B01D 2257/402; B01D 2257/404; B01D 2258/01; B01D 2258/0283; B01J 2229/20

(57) ABSTRACT

The invention relates to a process for preparing a catalyst based on a high-purity Nu-86 zeolite and on iron, comprising at least the following steps:
i) mixing, in aqueous medium, of at least one source of silicon (Si) in SiO₂ oxide form, at least one source of aluminum (Al) in Al₂O₃ oxide form, a nitrogen-containing organic compound R, R being octamethonium bromide (OctBr₂), at least two sodium sources, one of these being sodium bromide (NaBr), until a homogeneous precursor gel is obtained;
ii) maturation of the gel so as to promote the formation of said zeolite to the detriment of impurities; iii) hydrothermal treatment of said precursor gel in order to obtain a solid crystalline phase; iv) at least one ion exchange with iron, v) heat treatment.

The invention also relates to the catalyst which is capable of being obtained or directly obtained by the process and to the use thereof for the conversion of NOx and/or N₂O.

### TECHNICAL FIELD OF THE INVENTION

The invention provides a process for preparing a catalyst based on an Nu-86 zeolite and on at least one transition metal, in particular iron, the catalyst prepared or capable of being prepared by the process, and the use thereof for the simultaneous reduction of nitrogen oxides (NOx) and of dinitrogen oxide (N₂O), in particular in combustion processes and industrial processes such as the production of nitric and adipic acid.

### PRIOR ART

Emissions of nitrogen oxides (NOx) resulting from combustion are a major concern for society as they are responsible for health problems, ground-level ozone, acid rain and smog. Increasingly stringent standards have been put in place by government authorities in order to limit the impact on the environment and on health. Highly efficient pollution control systems such as three-way catalysts or selective catalytic reduction catalysts, referred to by the acronym “SCR”, have therefore been developed to equip means of transport in order to achieve these objectives. However, it is not uncommon for the selectivity of these systems to cause emissions of dinitrogen oxide (N₂O). Dinitrogen oxide is the third greatest contributor to radiative forcing after carbon dioxide (CO₂) and methane (CH₄). In addition to affecting stratospheric ozone, a given amount of N₂O in the atmosphere has 298 times more of an effect on global warming over 100 years than the same amount of CO₂, according to the 4^{th} Report of the IPCC.

Ammonia is considered to be an important fuel for decarbonization. However, the combustion of ammonia (or of an H₂/NH₃ mixture) exhibits potentially significant emissions of N₂O, NOx and NH₃ at the exhaust.

Other sectors are responsible for high emissions of NOx and N₂O; the nitric acid industry is one of the main sources of dinitrogen oxide (N₂O) emissions. N₂O is formed as a by-product of the oxidation of ammonia over a Pt/Rh catalyst. NOx, which are the main product at the outlet of the Pt/Rh catalyst, are then absorbed in water to form nitric acid. The absorption step is not 100% efficient and gives rise to NOx emissions at the outlet (100 to 500 ppm).

Treatment of the NOx and N₂O for applications related to decarbonization and industrial flue gases is therefore necessary.

The treatment of NOx has already been the subject of a great deal of work, both in industry and transportation. For the treatment of N₂O, several types of catalysts have been studied according to the temperature at which they are effective. Precious metals have good efficiencies around 250° C., but are expensive and very often are deactivated in the presence of inhibitors (CO, H₂O, NOx, O₂, etc.), which is not compatible with the constraints of nitric or adipic acid production. Zeolites, for their part, are relatively low cost and have a very large developed surface area which makes it possible to obtain a good catalytic system by incorporating a transition metal, in particular iron. Sádovská et al. (Sádovská, G., Bernauer, M., Bernauer, B., Tabor, E., Vondrová, A., & Sobalík, Z. (2018). On the mechanism of high-temperature N₂O decomposition over Fe-FER in the presence of NO. Catalysis Communications, 112, 58-62) have shown that zeolites of FER type containing iron had very considerable performance qualities in terms of the decomposition of N₂O and that there was a positive effect of NO for the decomposition even at 600-900° C. The FER structure which has Al pairs resists high temperature 900° C. deN₂O conditions (Tabor, E., Mlekodaj, K., Sádovská, G., Bernauer, M., Klein, P., Sazama, P., . . . & Sobalík, Z. (2019). Structural stability of metal containing ferrierite under the conditions of HT-N2O decomposition. Microporous and Mesoporous Materials, 281, 15-22.).

The presence of a cation, in particular iron, promotes decomposition but increasing the content above 1% does not seem to promote activity for an Fe-BEA zeolite. (Chen, B., Liu, N., Liu, X., Zhang, R., Li, Y., Li, Y., & Sun, X. (2011). Study on the direct decomposition of nitrous oxide over Fe-beta zeolites: From experiment to theory. Catalysis today, 175 (1), 245-255).

The redox behavior of Fe species in Fe-ZSM-5 catalysts for the decomposition of N₂O and NH₃-SCR of NOx was analyzed by Sazama et al. (Sazama, P., Wichterlova, B., Tábor, E., Šťastný, P., Sathu, N. K., Sobalík, Z., . . . & Vondrová, A. (2014). Tailoring of the structure of Fe-cationic species in Fe-ZSM-5 by distribution of Al atoms in the framework for N₂O decomposition and NH₃-SCR-NOx. Journal of catalysis, 312, 123-138.).

It is possible to combine the reduction of NOx and of N₂O in a single reactor. In the case of a nitric acid plant, Groves et al. (Michael C. E. Groves & Alexander Sasonow (2010) Uhde EnviNOx® technology for NOX and N₂O abatement: a contribution to reducing emissions from nitric acid plants, Journal of Integrative Environmental Sciences, 7: S1, 211-222) tested different configurations: a stage of decomposition of N₂O, combined with an NH₃-SCR stage; a deNOx stage followed by a reduction of N₂O with ammonia or with hydrocarbons (methane or propane).

The use of Nu-86-type zeolites for NH₃-SCR applications is known (U.S. Pat. No. 6,126,912), but no work has evaluated the efficiency of catalysts in deN₂O or simultaneous deNOx/deN₂O operation.

### SUMMARY OF THE INVENTION

The applicant has discovered that a catalyst based on/comprising a zeolite of Nu-86 type, prepared in accordance with a particular synthesis method, and on iron as transition metal, exhibited advantageous performance qualities in terms of simultaneous conversion of NOx and of N₂O. The performance qualities of the conversion of NOx and of N₂O with a reducing agent, in particular over the temperature range extending from 300 to 500° C., are in particular superior to those obtained with prior art catalysts, such as catalysts based on iron-exchanged zeolite of FER structural type. The properties of direct decomposition of N₂O using this catalyst are also particularly advantageous starting from 450° C.

The invention relates to a process for preparing a catalyst based on a zeolite of Nu-86 structural type and on iron, comprising at least the following steps:
i) mixing, in aqueous medium, of at least one source of silicon (Si) in SiO₂ oxide form, at least one source of aluminum (AI) in Al₂O₃ oxide form, a nitrogen-containing organic compound R, R being octamethonium bromide (OctBr₂), at least two sodium sources, one of these being sodium bromide (NaBr), the reaction mixture having the following molar composition:
SiO₂/Al₂O₃ of between 8 and 20,
H₂O/SiO₂ of between 15 and 60,
R/SiO₂ of between 0.05 and 0.35,
Na₂O/SiO₂ of between 0.05 and 0.3,
NaBr/SiO₂ of between 0.01 and 0.1, limits included,
step i) being conducted for a duration of between 5 and 15 minutes until a homogeneous mixture referred to as precursor gel is obtained;
ii) maturation of the precursor gel obtained on said step i) at a temperature of between 2° and 100° C., with or without stirring, for a duration of between 10 minutes and 48 hours, preferably between 18 and 24 hours;
iii) hydrothermal treatment of said precursor gel obtained on step ii) at a temperature of between 120° C. and 220° C., preferably between 14° and 195° C., for a duration of between 12 hours and 35 days, preferably between 12 hours and 33 days, until said Nu-86 zeolite forms;
iv) at least one ion exchange, comprising bringing said dried zeolite obtained on conclusion of the preceding step into contact with a solution comprising at least one species capable of releasing iron, in solution in reactive form with stirring at a temperature between 2° and 95° C., preferably between 4° and 90° C., for a duration of between 1 hour and 2 days;
v) heat treatment by drying of the Nu-86 zeolite obtained on the preceding step at a temperature of between 2° and 150° C. for a duration of between 2 and 24 hours followed by at least one calcination under a stream of air at a temperature of between 40° and 700° C. for a duration of between 2 and 20 hours.

Steps iv) and v) may be inverted, and optionally repeated.

In this case, the Nu-86 zeolite obtained in step iii) may directly undergo a step v) of heat treatment, then at least one exchange of ions with an acid, or a compound such as ammonium chloride, sulfate or nitrate, in order to obtain a calcined Nu-86 zeolite in protonated form, before step iv) of ion exchange with iron.

Seed crystals of a zeolite of Nu-86 structural type may be added to the reaction mixture of step i) in an amount of between 0.01% and 10% of the total mass of the sources of the tetravalent (Si) and trivalent (Al) elements in their oxide form (SiO₂ and Al₂O₃) in anhydrous form which are used in the reaction mixture, said seed crystals not being taken into account in the total mass of the sources of the tetravalent and trivalent elements.

The content of iron introduced by the ion exchange step iv) is between 0.5% and 6% by mass, preferably between 0.5% and 5% by mass, more preferably between 1% and 4% by mass, relative to the total mass of the anhydrous final catalyst.

The invention also relates to a catalyst based on an Nu-86 zeolite and on iron for the decomposition of N₂O or the reduction of N₂O or the simultaneous reduction of NOx and of N₂O by a reducing agent such as NH₃ or H₂, which is capable of being obtained or directly obtained by the preparation process according to any one of its variants.

The content of iron in the catalyst may be between 0.5% and 6% by mass, preferably between 0.5% and 5% by mass, more preferably between 1% and 4% by mass, relative to the total mass of the anhydrous final catalyst.

The invention also relates to a process for the decomposition of N₂O or the reduction of N₂O or the simultaneous reduction of NOx and of N₂O by a reducing agent such as NH₃ or H₂, wherein the gas to be treated is brought into contact with a catalyst according to any one of the variants described.

The catalyst may be formed by deposition in the form of a coating, on a honeycomb structure or a plate structure, or said catalyst may be in the form of an extrudate or bead, containing up to 100% of said catalyst.

Said honeycomb structure may be formed by parallel channels which are open at both ends or may comprise porous filtering walls in the case of which adjacent parallel channels are alternately blocked at either end of the channels.

The amount of catalyst deposited on said structure may be between 50 to 250 g/L for the filtering structures and between 80 and 300 g/L for the structures with open channels.

The catalyst may be combined with a binder such as ceria, zirconium oxide, alumina, non-zeolitic silica-alumina, titanium oxide, a mixed oxide of ceria-zirconia type, a tungsten oxide and/or a spinel in order to be formed by deposition in the form of a coating, it being possible preferably for said coating to be combined with another coating having the capacity to adsorb pollutants, in particular NOx, to reduce pollutants, in particular NOx, or promoting the oxidation of pollutants.

Said catalyst may be integrated:
into an exhaust line of an internal combustion engine running on carbon-based or non-carbon-based fuels, or
into a reactor for treating industrial flue gases.

### LIST OF THE FIGURES

Other characteristics and advantages of the process for preparing the catalyst according to the invention will become apparent on reading the following description of non-limiting exemplary embodiments with reference to the appended FIGURES described below.

FIG. 1 represents the X-ray diffraction (XRD) patterns of the catalyst based on Nu-86 zeolite and containing iron, Fe-Nu-86, obtained according to example 1.

### DESCRIPTION OF THE EMBODIMENTS

The invention relates to a process for preparing a catalyst based on an Nu-86 zeolite and on iron, comprising at least the following steps:
i) mixing, in aqueous medium, of at least one source of silicon (Si) in SiO₂ oxide form, at least one source of aluminum (Al) in Al₂O₃ oxide form, a nitrogen-containing organic compound R, R being octamethonium bromide (OctBr₂), at least two sodium sources, one of these being sodium bromide (NaBr), the reaction mixture having the following molar composition:
SiO₂/Al₂O₃ of between 8 and 20,
H₂O/SiO₂ of between 15 and 60,
R/SiO₂ of between 0.05 and 0.35,
Na₂O/SiO₂ of between 0.05 and 0.3,
NaBr/SiO₂ of between 0.01 and 0.1, limits included,
step i) being conducted for a duration of between 5 and 15 minutes until a homogeneous mixture referred to as precursor gel is obtained;
ii) maturation of the precursor gel of said step i) at a temperature of between 2° and 100° C., with or without stirring, for a duration of between 10 minutes and 48 hours, preferably between 18 and 24 hours;
iii) hydrothermal treatment of said precursor gel obtained at step ii) at a temperature of between 120° C. and 220° C., for a duration of between 12 hours and 35 days, until said Nu-86 zeolite forms;
iv) at least one ion exchange, comprising bringing said Nu-86 zeolite obtained at the preceding step into contact with a solution comprising at least one species capable of releasing a transition metal, in particular iron, in solution in reactive form with stirring at a temperature of between 2° and 95° C., preferably between 4° and 90° C., for a duration of between 1 hour and 2 days;
v) heat treatment by drying of said Nu-86 zeolite obtained at the preceding step at a temperature of between 2° and 150° C. followed by at least one calcination under a stream of air at a temperature of between 40° and 700° C.

Steps iv) and v) may be inverted, and optionally repeated.

The Nu-86 zeolite obtained in step iii) may in this case directly undergo step v) of heat treatment, then an exchange of ions with an acid, or a compound such as ammonium chloride, sulfate or nitrate, in order to obtain a calcined Nu-86 zeolite in protonated form, before step iv) of ion exchange with iron.

Seed crystals of an Nu-86 zeolite may then be added to the reaction mixture of step i), preferably in an amount of between 0.01% and 10% by weight relative to the total mass of the sources of the tetravalent and trivalent elements in anhydrous form which are present in said mixture, said seed crystals not being taken into account in the total mass of the sources of SiO₂ and Al₂O₃.

Step i) may comprise a step of maturation of the reaction mixture at a temperature of between 2° and 100° C., with or without stirring, for a duration of between 30 minutes and 48 hours.

The hydrothermal treatment of step iii) may be carried out under autogenous pressure at a temperature of between 120° C. and 220° C., preferably between 140° C. and 195° C., for a duration of between 12 hours and 35 days, preferably between 12 hours and 33 days.

The Nu-86 zeolite obtained on conclusion of step iii) is advantageously filtered off, washed and dried at a temperature of between 6° and 120° C., for a duration of between 5 and 24 hours, in order to obtain a dried Nu-86 zeolite.

Ion exchange step iv) may be carried out by bringing the solid into contact with a solution comprising a single species capable of releasing a transition metal or by successively bringing the solid into contact with different solutions each comprising at least one, preferably a single, species capable of releasing a transition metal, the transition metal being iron.

The content of iron introduced by the ion exchange step iv) is advantageously between 0.5% and 6% by mass, preferably between 0.5% and 5% by mass, more preferably between 1% and 4% by mass, relative to the total mass of the anhydrous final catalyst.

Advantageously, heat treatment step v) comprises drying of the solid at a temperature of between 2° and 150° C., preferably between 6° and 100° C., for a duration of between 2 and 24 hours, followed by at least one calcination under—optionally dry—air at a temperature of between 40° and 700° C., preferably between 50° and 600° C., for a duration of between 2 and 20 hours, preferably between 5 and 10 hours, more preferably between 6 and 9 hours, the flow rate of optionally dry air being preferably between 0.5 and 1.5 L/h/g of solid to be treated, more preferably between 0.7 and 1.2 L/h/g of solid to be treated.

The invention also relates to the catalyst based on an Nu-86 zeolite and on iron, capable of being obtained or directly obtained by the preparation process.

The content of iron in the catalyst obtained is advantageously between 0.5% and 6% by mass, preferably between 0.5% and 5% by mass, relative to the total mass of the anhydrous final catalyst.

The invention also relates to the use of the catalyst according to any one of the variants thereof or of the catalyst capable of being obtained or directly obtained by the preparation process, for the selective reduction of NOx by a reducing agent such as NH₃ or H₂.

The invention also relates to the use of the catalyst described above or the use of the catalyst capable of being obtained or directly obtained by the preparation process, for the direct decomposition of N₂O or the simultaneous reduction of NOx and of N₂O by a reducing agent such as NH₃ or H₂.

The catalyst may be formed directly by extrusion in pellet form or by deposition in the form of a coating on a honeycomb structure or a plate structure.

The honeycomb structure may be formed by parallel channels which are open at both ends or may comprise porous filtering walls in the case of which adjacent parallel channels are alternately blocked at either end of the channels.

The amount of catalyst deposited on said structure may advantageously be between 50 to 200 g/L for the filtering structures and between 80 and 300 g/L for the structures with open channels.

The catalyst may be combined with a binder such as ceria, zirconium oxide, alumina, non-zeolitic silica-alumina, titanium oxide, a mixed oxide of ceria-zirconia type, a tungsten oxide and/or a spinel in order to be formed by deposition in the form of a coating.

Said coating may be combined with another coating having the capacity to adsorb pollutants, in particular nitrogen oxides, to reduce pollutants, in particular NOx, or promoting the oxidation of pollutants, such as CO or hydrocarbons.

Said catalyst may be in the form of an extrudate or bead or any other form known to those skilled in the art, containing up to 100% of said catalyst.

The support of the catalyst used in the process according to the invention may advantageously be formed by any technique known to those skilled in the art. The forming may advantageously be carried out, for example, by extrusion, by pelletizing, by the oil drop coagulation method, by rotating plate granulation or by any other method well known to those skilled in the art. The supports thus obtained may be in various shapes and sizes. Advantageously, the various constituents of the support or of the catalyst may be formed by means of a kneading step so as to form a paste, then extrusion of the paste obtained, or else by mixing powders then pelletizing, or else by any other known process for agglomeration of a powder containing alumina. The supports thus obtained may be in various shapes and sizes. Preferably, the forming is performed by kneading and extrusion.

Moreover, the use of additives may advantageously be implemented to facilitate the forming and/or to improve the final mechanical properties of the supports, as is well known to those skilled in the art. Examples of additives that may be mentioned in particular include cellulose, carboxymethylcellulose, carboxyethylcellulose, tall oil, xanthan gums, surfactants, flocculants such as polyacrylamides, carbon black, starches, stearic acid, polyacrylic alcohol, polyvinyl alcohol, biopolymers, glucose, polyethylene glycols, etc.

Water may advantageously be added or removed in order to adjust the viscosity of the paste to be extruded. This step may advantageously be carried out at any stage in the kneading step.

In order to adjust the solids content of the paste to be extruded so as to make it extrudable, a compound that is predominantly solid, preferably an oxide or a hydrate, may also be added. A hydrate is preferably used, and more preferably still an aluminum hydrate. The loss on ignition of this hydrate is advantageously greater than 15%.

Extrusion of the paste resulting from the kneading step may advantageously be carried out with any conventional commercially available tool. The paste resulting from the kneading is advantageously extruded through a die, for example using a piston or a single-screw or twin-screw extruder. The extrusion may advantageously be carried out by any method known to those skilled in the art.

The supports of the catalyst according to the invention are generally in the form of cylindrical extrudates or polylobal extrudates such as bilobal, trilobal or polylobal extrudates of straight or twisted form, but may optionally be manufactured and used in the form of crushed powders, tablets, rings, beads and/or wheels. Preferably, the supports of the catalyst according to the invention may be in the form of spheres or extrudates. Advantageously, the support may be in the form of extrudates with a diameter of between 0.5 and 5 mm and more particularly between 0.7 and 2.5 mm. The forms may be cylindrical (which may or may not be hollow) and/or twisted and/or multilobal (for example 2, 3, 4 or 5 lobes) cylindrical and/or annular. The multilobal form is advantageously preferably used.

The structure coated with said catalyst or obtained by extrusion of said catalyst may be integrated:
into an exhaust line of an internal combustion engine running on carbon-based or non-carbon-based fuels, such as NH₃, H₂, etc. (non-exhaustively)
into a reactor for treating industrial flue gases. In a nitric acid plant, it may be integrated into a tertiary stage, either to sequentially remove N₂O by decomposition and NOx with the addition of a reducing agent such as NH₃ or to concomitantly remove NOx and N₂O with the addition of a reducing agent.

### The Catalyst

The catalyst according to the invention comprises at least one Nu-86 zeolite and iron.

The total content of iron is between 0.5% and 6% by mass, preferably between 0.5% and 5% by mass, relative to the total mass of the final catalyst in its anhydrous form.

The catalyst according to the invention may also comprise other elements, such as for example alkali and/or alkaline-earth metals, for example sodium, originating especially from the synthesis, in particular of the compounds of the reaction medium of step i) of the process for preparing said catalyst.

### Process for Preparing the Catalyst

### Mixing Step i)

Step i) implements:
i) mixing, in aqueous medium, of at least one source of silicon (Si) in SiO₂ oxide form, at least one source of aluminum (Al) in Al₂O₃ oxide form, a nitrogen-containing organic compound R, R being octamethonium bromide (OctBr₂), at least two sodium sources, at least one of these being sodium bromide (NaBr), the reaction mixture having the following molar composition:
SiO₂/Al₂O₃ of between 8 and 20,
H₂O/SiO₂ of between 15 and 60,
R/SiO₂ of between 0.05 and 0.35,
Na₂O/SiO₂ of between 0.05 and 0.3,
NaBr/SiO₂ of between 0.01 and 0.1, limits included,
in which H₂O corresponds to the molar amount of water present in the reaction mixture, R the molar amount of said nitrogen-containing organic compound, Na₂O the molar amount expressed in sodium oxide form, step i) being conducted for a duration making it possible to obtain a homogeneous mixture referred to as precursor gel, generally of from 5 to 15 minutes, once all the components have been introduced into the reaction mixture.

The source of silicon may be any one of said sources commonly used for zeolite synthesis, for example powdered silica, silicic acid, colloidal silica, dissolved silica or tetraethoxysilane (TEOS). Among the powdered silicas, use may be made of precipitated silicas, especially those obtained by precipitation from a solution of alkali metal silicate, fumed silicas, for example Cab-O-Sil, and silica gels.

Colloidal silicas having various particle sizes, for example a mean equivalent diameter of between 10 and 15 nm or between 40 and 50 nm, may be used, such as those sold under registered trademarks such as Ludox. Preferably, the source of silicon is Aerosil 200.

In accordance with the invention, the source of aluminum is preferably aluminum hydroxide or an aluminum salt, for example chloride, nitrate or sulfate, a sodium aluminate, an aluminum alkoxide, or alumina itself, preferably in hydrated or hydratable form, for instance colloidal alumina, pseudoboehmite, gamma-alumina or alpha or beta alumina trihydrate. Use may also be made of mixtures of the abovementioned sources.

Step (i) of the process according to the invention consists in preparing an aqueous reaction mixture containing at least one source of silicon, at least one source of aluminum, at least one nitrogen-containing organic compound R, R being octamethonium bromide (OctBr₂), in the presence of at least two sodium sources, one of these being sodium bromide (NaBr), in order to obtain a precursor gel of an Nu-86 zeolite. The amounts of said reactants are adjusted as indicated above so as to give this gel a composition that enables the crystallization of an Nu-86 zeolite.

It may be advantageous to add seeds of an Nu-86 zeolite to the reaction mixture during said step i) of the process of the invention so as to reduce the time needed for the formation of the crystals of an Nu-86 zeolite and/or the total crystallization time. Said seed crystals also promote the formation of said Nu-86 zeolite to the detriment of impurities. Such seeds comprise crystalline solids, in particular crystals of an Nu-86 zeolite. The seed crystals are generally added in a proportion of between 0.01% and 10% of the anhydrous total mass of the sources of said tetravalent (Si) and trivalent (Al) elements used in the reaction mixture, said seed crystals not being taken into account in the total mass of the sources of the tetravalent and trivalent elements. Said seeds are not taken into account either for determining the composition of the reaction mixture and/or of the gel, defined above, i.e. in the determination of the various molar ratios of the composition of the reaction mixture.

The mixing step i) is performed until a homogeneous mixture is obtained, preferably for a duration of between 5 and 15 minutes, preferably with stirring by any system known to those skilled in the art, at a low or high shear rate.

On conclusion of step i), a homogeneous precursor gel is obtained.

### Step ii) Maturation of the Precursor Gel

Step ii) implements maturation of the reaction mixture before the hydrothermal crystallization so as to promote the formation of said Nu-86 zeolite to the detriment of impurities. The maturation of the reaction mixture during said step ii) of the process of the invention may be carried out at ambient temperature or at a temperature of between 2° and 100° C., with or without stirring, for a duration advantageously of between 10 minutes and 48 hours, preferably between 18 and 24 hours.

Hydrothermal Treatment Step iii)

In accordance with step iii) of the process according to the invention, the precursor gel obtained on conclusion of step ii) is subjected to a hydrothermal treatment, preferentially carried out at a temperature of between 120° C. and 220° C. for a duration of between 12 hours and 35 days, until said Nu-86 zeolite (or “crystalline solid”) forms.

The precursor gel is advantageously placed under hydrothermal conditions under an autogenous reaction pressure, optionally with addition of gas, for example nitrogen, at a temperature preferably of between 120° C. and 220° C., preferably between 140° C. and 195° C., until an Nu-86 zeolite has fully crystallized.

The duration required to obtain crystallization ranges between 12 hours and 35 days, preferably between 12 days and 33 days.

The reaction is generally carried out with or without stirring, preferably with stirring. The stirring system that may be used is any system known to those skilled in the art, for example inclined blades with counter-blades, stirring turbomixers or Archimedes' screws.

Very advantageously, the process of the invention leads to the formation of an Nu-86 zeolite, free of any other crystalline or amorphous phase.

The hydrothermal treatment of step iii) may be followed by filtration, washing and drying of the Nu-86 zeolite obtained, advantageously at a temperature of between 6° and 120° C., for a duration of between 5 and 24 hours, in order to obtain a dried Nu-86 zeolite before ion exchange step iv).

It is also advantageous to obtain the protonated form of the Nu-86-type zeolite after step iii). In this embodiment, said protonated form may be obtained by performing an exchange of ions with an acid, in particular a strong mineral acid such as hydrochloric, sulfuric or nitric acid, or with a compound such as ammonium chloride, sulfate or nitrate, before the ion exchange iv) with iron.

In this embodiment, the zeolite of Nu-86 structural type obtained on conclusion of step iii) directly undergoes a heat treatment (step v) comprising drying at a temperature of between 2° and 150° C., preferably between 6° and 100° C., for a duration of between 2 and 24 hours, followed by at least one calcination under—optionally dry—air at a temperature of between 40° and 700° C., preferably between 50° and 600° C., for a duration of between 2 and 20 hours, preferably between 5 and 10 hours, more preferably between 6 and 9 hours, the flow rate of optionally dry air being preferably between 0.5 and 1.5 L/h/g of solid to be treated, more preferably between 0.7 and 1.2 L/h/g of solid to be treated. The calcination may be preceded by a gradual temperature increase. The dried and calcined Nu-86 zeolite then undergoes at least one exchange of ions with an acid, or a compound such as ammonium chloride, sulfate or nitrate, in order to obtain a calcined Nu-86 zeolite in protonated form, before step iv) of ion exchange with iron.

### Ion Exchange Step iv)

The process for preparing the catalyst according to the invention comprises at least one ion exchange step comprising bringing the crystalline solid obtained on conclusion of the preceding step, i.e. the Nu-86 zeolite obtained on conclusion of step iii) or the dried and calcined Nu-86 zeolite obtained on conclusion of step v) in the preferred case where steps iv) and v) are inverted, or the dried, calcined and protonated Nu-86 zeolite, into contact with at least one solution comprising at least one species capable of releasing a transition metal, in this case iron, in solution in reactive form, with stirring at ambient temperature for a duration of between 1 hour and 2 days, advantageously for a duration of between 0.5 days and 1.5 days, the concentration of said species capable of releasing iron in said solution depending on the amount of iron to be incorporated into said crystalline solid.

The transition metal released in the exchange solution is iron.

According to the invention, “species capable of releasing a transition metal” is understood to mean a species which is capable of dissociating in an aqueous medium, such as for example sulfates, nitrates, chlorides, oxalates, or organometallic complexes of a transition metal, or mixtures thereof. Preferably, the species capable of releasing a transition metal is a sulfate or a nitrate of said transition metal.

According to the invention, the solution with which the crystalline solid or dried and calcined crystalline solid is brought into contact comprises at least one species capable of releasing a transition metal, preferably a single species capable of releasing a transition metal, in this case iron.

Advantageously, the process for preparing the catalyst according to the invention may comprise a step iv) of ion exchanges by bringing the crystalline solid into contact with a solution comprising a species capable of releasing a transition metal or by successively bringing the solid into contact with a plurality of solutions each comprising a species capable of releasing a transition metal, said metal being iron.

At the end of the ion exchange, the solid obtained may advantageously be filtered off, washed and then dried in order to obtain said catalyst in powder form.

The total amount of iron contained in said final catalyst is between 0.5% and 6% by mass relative to the total mass of the catalyst in its anhydrous form.

According to one embodiment, the catalyst according to the invention is prepared by a process comprising a step iv) of ion exchange, the solid or the dried and calcined solid being brought into contact with a solution comprising a species capable of releasing iron in solution in reactive form. Advantageously, the total amount of iron contained in said final catalyst, that is to say on conclusion of the preparation process according to the invention, is between 0.5% and 6%, preferably between 0.5% and 5% by mass, all the percentages being percentages by mass relative to the total mass of the final catalyst according to the invention in its anhydrous form, obtained on conclusion of the preparation process.

### Heat Treatment Step v)

The preparation process according to the invention comprises a step v) of heat treatment carried out on conclusion of the preceding step, i.e. on conclusion of the hydrothermal treatment step iii) or on conclusion of the ion exchange step iv), preferably on conclusion of the ion exchange step iv). Step iv) and step v) of the preparation process may advantageously be inverted. Each of steps iv) and v) may also optionally be repeated.

Said heat treatment step v) comprises drying of the solid at a temperature of between 2° and 150° C., preferably between 6° and 100° C., advantageously for a duration of between 2 and 24 hours, followed by at least one calcination, under—optionally dry—air, at a temperature advantageously of between 40° and 700° C., preferably between 500 and 600° C. for a duration of between 2 and 20 hours, preferably between 5 and 10 hours, more preferably between 6 and 9 hours, the flow rate of optionally dry air being preferably between 0.5 and 1.5 L/h/g of solid to be treated, more preferably between 0.7 and 1.2 L/h/g of solid to be treated. The calcination may be preceded by a gradual temperature increase.

The catalyst obtained on conclusion of the heat treatment step v) is devoid of any organic species, in particular devoid of the organic structuring agent R.

In particular, the catalyst obtained by a process comprising at least steps i), ii), iii), iv) and v) as described above has improved N₂O conversion properties.

### Characterization of the Catalyst Prepared According to the Invention

The catalyst comprises a zeolite of Nu-86 structure. This structure is characterized by X-ray diffraction (XRD).

The X-ray diffraction (XRD) pattern is obtained by radiocrystallographic analysis by means of a diffractometer using the conventional powder method with copper Kα₁ radiation (2=1.5406 Å). On the basis of the position of the diffraction peaks represented by the angle 20, the lattice interplanar spacings dₕₖₗ characteristic of the sample are calculated using Bragg's law. The measurement error Δ(dₕₖₗ) on dₕₖₗ is calculated by means of Bragg's law as a function of the absolute error Δ(2θ) assigned to the measurement of 2θ. An absolute error Δ(2θ) equal to +0.02° is commonly accepted. The relative intensity Iᵣₑₗ assigned to each value of dₕₖₗ is measured from the height of the corresponding diffraction peak. The X-ray diffraction pattern of the crystalline solid obtained on conclusion of step iii) of the process according to the invention includes at least the lines at the values of dₕₖₗ given in table 1 (mean values of dₕₖₗ and relative intensities measured on an X-ray diffraction pattern of the calcined zeolitic catalyst of Nu-86 structural type according to the invention). In the column of the dₕₖₗ values, the mean values of the lattice spacings have been shown in angstroms (Å). Each of these values must be assigned the measurement error Δ(dₕₖₗ) of between ±0.6 Å and ±0.01 Å.

TABLE 1

| 2 theta (°) | dₕₖₗ (Å) | Iᵣₑₗ | 2 theta (°) | dₕₖₗ (Å) | Iᵣₑₗ |
|---|---|---|---|---|---|
| 6.566 | 13.45 | w | 20.973 | 4.23 | vw |
| 7.847 | 11.26 | S | 21.448 | 4.14 | w |
| 7.535 | 11.72 | S | 22.177 | 4.01 | w |
| 7.953 | 11.11 | M | 22.501 | 3.95 | S |
| 9.013 | 9.80 | w | 22.631 | 3.93 | VS |
| 10.363 | 8.53 | vw | 22.783 | 3.90 | VS |
| 12.487 | 7.08 | vw | 25.152 | 3.54 | vw |
| 14.143 | 6.26 | vw | 26.956 | 3.30 | vw |
| 14.629 | 6.05 | vw | 28.75 | 3.10 | vw |
| 15.519 | 5.71 | vw | | | |

where VS = very strong; S = strong; m = medium; mw = moderately weak; w = weak; vw = very weak. The relative intensity Iᵣₑₗ is given in relation to a relative intensity scale in which a value of 100 is assigned to the most intense line of the X-ray diffraction pattern: vw < 15; 15 ≤ w < 30; 30 ≤ mw < 50; 50 ≤ m < 65; 65 ≤ S < 85; VS ≥ 85.

The qualitative and quantitative analysis of the chemical species present in the materials obtained is carried out by X-ray fluorescence (XRF) spectrometry. This is a chemical analysis technique which uses a physical property of matter, X-ray fluorescence. It makes possible the analysis of the majority of chemical elements starting from beryllium (Be) in concentration ranges extending from a few ppm to 100%, with precise and reproducible results. X-rays are used to excite the atoms in a sample, which causes them to emit X-rays having an energy characteristic of each element present. The intensity and the energy of these X-rays are subsequently measured in order to determine the concentration of the elements in the material.

The loss on ignition (LOI) of the catalyst obtained after the drying step (and before calcination) or after the calcination step of step iv) of the process according to the invention is generally between 4% and 15% by weight. The loss on ignition of a sample, referred to by the acronym LOI, corresponds to the difference in mass of the sample before and after a heat treatment at 1000° C. for 2 hours. It is expressed in % corresponding to the percentage loss of mass. The loss on ignition corresponds in general to the loss of solvent (such as water) contained in the solid, but also to the removal of organic compounds contained in the mineral solid constituents.

### Use of the Catalyst According to the Invention

The invention also relates to the use of the catalyst according to the invention, directly prepared or capable of being prepared by the process described above, for the direct decomposition of N₂O or the reduction of NOx and N₂O by a reducing agent such as NH₃ or a hydrocarbon, advantageously formed by deposition in the form of a coating (or “washcoat”) on a honeycomb structure, primarily for mobile applications, or on a plate structure, as found in particular for stationary applications. The invention may also be formed in the form of extrudates or beads. Preferably, the supports of the catalyst according to the invention are in the form of spheres or extrudates. Advantageously, the support is in the form of extrudates with a diameter of between 0.5 and 5 mm and more particularly between 0.7 and 2.5 mm. The forms may be cylindrical (which may or may not be hollow) and/or twisted and/or multilobal (for example 2, 3, 4 or 5 lobes) cylindrical and/or annular. The multilobal form is advantageously preferably used.

The honeycomb structure is formed of parallel channels which are open at both ends (“flow-through channels”) or comprises porous filtering walls, in which case adjacent parallel channels are alternately blocked at either end of the channels in order to force the gas flow to pass through the wall (“wall-flow monolith”).

Said honeycomb structure thus coated constitutes a catalytic block. Said structure may be composed of cordierite, silicon carbide (SiC), aluminum titanate (AlTi), alpha-alumina, mullite, or any other material having a porosity of between 30% and 70%. Said structure may be formed in metal sheet, in stainless steel containing chromium and aluminum, FeCrAl steel.

The amount of catalyst according to the invention deposited on said structure is between 50 to 250 g/L for the filtering structures and between 80 and 300 g/L for the structures with open channels.

The actual coating (“washcoat”) comprises the catalyst according to the invention, advantageously in combination with a binder such as ceria, zirconium oxide, alumina, non-zeolitic silica-alumina, titanium oxide, a mixed oxide of ceria-zirconia type, a tungsten oxide, a spinel. Said coating is advantageously applied to said structure by a deposition method known as washcoating, which consists in soaking the monolith in a suspension (or slurry) of powdered catalyst according to the invention in a solvent, preferably water, and optionally binders, metal oxides, stabilizers or other promoters. This soaking step can be repeated until the desired amount of coating is obtained. In certain cases the slurry may also be sprayed inside the monolith. Once the coating has been deposited, the monolith is calcined at a temperature of 300 to 600° C. for 1 to 10 hours.

Said structure may be coated with one or more coatings. The coating comprising the catalyst according to the invention is advantageously combined with, i.e. covers or is covered by, another coating having the capacity to adsorb pollutants, in particular NOx, to reduce pollutants, in particular NOx, or promoting the oxidation of pollutants, in particular that of ammonia.

Another possibility is to render the catalyst into the form of an extrudate or bead or any other form known to those skilled in the art. In this case, the structure formed may contain up to 100% of catalyst according to the invention.

The support of the catalyst used in the process according to the invention may advantageously be formed by any technique known to those skilled in the art. The forming may advantageously be carried out, for example, by extrusion, by pelletizing, by the oil drop coagulation method, by rotating plate granulation or by any other method well known to those skilled in the art. The supports thus obtained may be in various shapes and sizes. Advantageously, the various constituents of the support or of the catalyst may be formed by means of a kneading step so as to form a paste, then extrusion of the paste obtained, or else by mixing powders then pelletizing, or else by any other known process for agglomeration of a powder containing alumina. The supports thus obtained may be in various shapes and sizes. Preferably, the forming is performed by kneading and extrusion.

Moreover, the use of additives may advantageously be implemented to facilitate the forming and/or to improve the final mechanical properties of the supports, as is well known to those skilled in the art. Examples of additives that may be mentioned in particular include cellulose, carboxymethylcellulose, carboxyethylcellulose, tall oil, xanthan gums, surfactants, flocculants such as polyacrylamides, carbon black, starches, stearic acid, polyacrylic alcohol, polyvinyl alcohol, biopolymers, glucose, polyethylene glycols, etc.

Water may advantageously be added or removed in order to adjust the viscosity of the paste to be extruded. This step may advantageously be carried out at any stage in the kneading step.

In order to adjust the solids content of the paste to be extruded so as to make it extrudable, a compound that is predominantly solid, preferably an oxide or a hydrate, may also be added. A hydrate is preferably used, and more preferably still an aluminum hydrate. The loss on ignition of this hydrate is advantageously greater than 15%.

Extrusion of the paste resulting from the kneading step may advantageously be carried out with any conventional commercially available tool. The paste resulting from the kneading is advantageously extruded through a die, for example using a piston or a single-screw or twin-screw extruder. The extrusion may advantageously be carried out by any method known to those skilled in the art.

The supports of the catalyst according to the invention are generally in the form of cylindrical extrudates or polylobal extrudates such as bilobal, trilobal or polylobal extrudates of straight or twisted form, but may optionally be manufactured and used in the form of crushed powders, tablets, rings, beads and/or wheels. Preferably, the supports of the catalyst according to the invention are in the form of spheres or extrudates. Advantageously, the support is in the form of extrudates with a diameter of between 0.5 and 5 mm and more particularly between 0.7 and 2.5 mm. The forms may be cylindrical (which may or may not be hollow) and/or twisted and/or multilobal (for example 2, 3, 4 or 5 lobes) cylindrical and/or annular. The multilobal form is advantageously preferably used.

### Advantages of the Invention

The catalyst according to the invention, based on an Nu-86 zeolite and on iron, has improved properties in terms of deNOx and deN₂O compared with the catalysts of the prior art. In a stream with a high concentration of N₂O, the performance qualities of conversion of NOx and N₂O with a reducing agent such as NH₃ are in particular superior to those obtained with catalysts based on zeolite of FER structural type, in particular over the temperature range extending from 300 to 500° C. The properties of direct decomposition of N₂O using this catalyst are also particularly advantageous starting from 450° C.

### EXAMPLES

### Example 1: Preparation of a Catalyst Containing an Nu-86 Zeolite and Iron According to the Invention Fe-Nu-86

271.72 g of an aqueous solution of octamethonium bromide (25% by weight, SACHEM) are mixed with 280.71 g of deionized water with stirring and at ambient temperature. 8.89 g of sodium hydroxide (98% by weight, Aldrich) are dissolved in the above mixture with stirring and at ambient temperature. 2.39 g of sodium bromide (NaBr, Prolabo) are then added with stirring and at ambient temperature. 4.13 g of sodium aluminate (NaAlO₂, CARLO ERBA) and then 140.4 g of deionized water are incorporated into the synthesis mixture, the latter being kept stirring for half an hour at ambient temperature. As soon as the suspension obtained is homogeneous, pouring-in of 41.8 g of fumed silica (Aerosil 200, Degussa) is commenced and the suspension obtained is kept stirring vigorously for 10 minutes at ambient temperature. The molar composition of the precursor gel is as follows: 1 SiO₂:0.031 Al₂O₃:0.255 OctaBr₂: 0.2 Na₂O:0.033 NaBr:50 H₂O, i.e. an SiO₂/Al₂O₃ ratio of 32.4. The precursor gel is then transferred, after homogenization, into a 1000 mL stainless steel reactor equipped with a stirring system with four inclined blades to follow a step of maturation at ambient temperature for 24 hours with stirring at 180 rpm. After the maturation step, the reactor is heated for 32 days with an increase in temperature of 0.4° C./min up to 155° C. and with stirring at 300 rpm in order to allow the crystallization of an Nu-86 zeolite. The crystallized product obtained is filtered off, washed with deionized water, and then dried for 12 hours at 100° C. The solid is then introduced into a muffle furnace where a calcination step is performed: the calcination cycle comprises an increase in temperature of 1.5° C./min up to 200° C., a steady stage at 200° C. maintained for 2 hours, an increase of 1° C./min up to 550° C., followed by a steady stage at 550° C. maintained for 12 hours, then a return to ambient temperature.

After calcination, the zeolite is brought into contact with a 1M aqueous solution of NH₄NO₃ for 1 hour with stirring at 80° C. The ratio between volume of solution and mass of zeolite was 19 (V/W). The solid obtained is filtered off and washed and the exchange procedure is repeated once more under the same conditions.

The material obtained is named NH₄-Nu-86 and is treated under a stream of dry air at 550° C. for 4 hours with a temperature increase gradient of 1° C./min. The material obtained is an Nu-86 zeolite in protonated form (H-Nu-86).

The H-Nu-86 zeolite is then brought into contact with an aqueous solution of Fe(NO₃)₃·9H₂O at 80° C. for 17 hours with stirring and a ratio of volume of solution to mass of zeolite equal to 200 (V/P). The final solid is centrifuged and dried overnight at 100° C.

The solid obtained after contacting with the Fe(NO₃)₃ solution is then calcined under a stream of air at 550° C. for 8 hours with a temperature increase gradient of 1° C./min. The material obtained is named Fe-Nu-86.

The Fe-Nu-86 catalyst thus prepared comprises 2.6% by weight of iron relative to the total weight of catalyst.

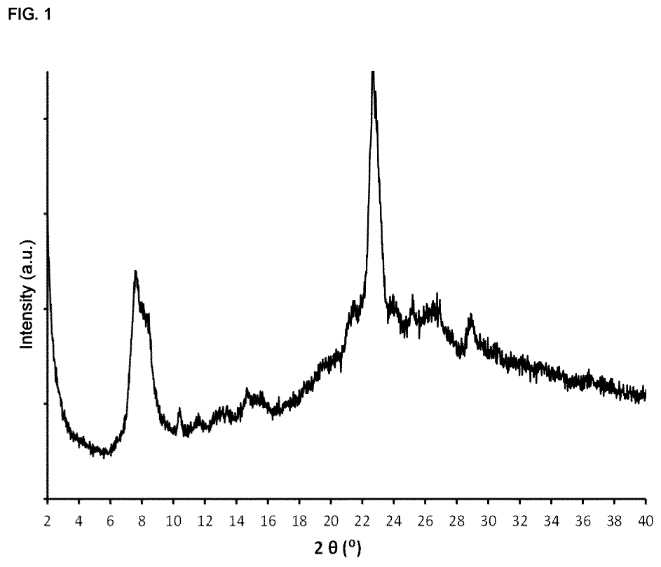

The Fe-Nu-86 catalyst was analyzed by X-ray diffraction and identified as consisting predominantly of an Nu-86 zeolite with a purity of greater than 99% by weight. The X-ray diffraction pattern produced for the catalyst Fe-Nu-86 is given in FIG. 1. The product has an SiO₂/Al₂O₃ molar ratio of 30 as determined by XRF.

### Example 2: Commercial Fe-Ferrierite (Fe-FER)

A commercial deNOx/deN₂O Fe-FER catalyst was provided. The product has an SiO₂/Al₂O₃ molar ratio of 17.5 and a percentage by mass of Fe of 2%, as determined by XRF. The catalyst obtained is denoted Fe-FER.

### Example 3: Conversion of NOx and N₂O: Comparison of the Catalysts According to the Invention with the Prior Art

A catalytic test of reduction of nitrogen oxides (NOx) and dinitrogen oxide (N₂O) by ammonia (NH₃) in the presence of oxygen (O₂) is carried out at different operating temperatures for the catalysts synthesized according to example 1 (Fe-Nu-86) and example 2 (Fe-FER).

For the test of each sample, 200 mg of catalyst in powder form are placed in a quartz reactor. 145 L/h of a gas mixture having the following molar composition are fed into the reactor: 200 ppm NO, 200 ppm NO₂, 200 ppm N₂O, 800 ppm NH₃, 8.5% O₂, 9% CO₂, 10% H₂O, remainder N₂.

An FTIR analyzer is used to measure the concentration of the species NO, NO₂, NH₃, N₂O, CO, CO₂, H₂O, O₂ at the reactor outlet. The NOx conversions are calculated as follows:

$$NO x conversion = ( NO x inlet - NO x outlet ) / NO x inlet$$

$${N}_{2} O conversion = ( {N}_{2} O inlet - {N}_{2} O outlet ) / {N}_{2} O inlet$$

In these formulae, the inlet and outlet indices respectively indicate the content before and after catalytic reduction.

The NOx conversion results are presented in table 2 below:

TABLE 2

| | 300° C. | 400° C. | 450° C. | 500° C. |
|---|---|---|---|---|
| Fe-Nu-86 | 100% | 100% | 100% | 100% |
| Fe-FER | 94% | 100% | 100% | 100% |

The N₂O conversion results are presented in table 3 below:

TABLE 3

| | 300° C. | 400° C. | 450° C. | 500° C. |
|---|---|---|---|---|
| Fe-Nu-86 | 0% | 10% | 31% | 70% |
| Fe-FER | 0% | 10% | 31% | 66% |

The Fe-Nu-86 catalyst synthesized according to the invention provides performance qualities superior to the Fe-FER catalyst in terms of NOx conversion, especially at low temperatures (300° C.). For the conversion of N₂O, the Fe-Nu-86 catalyst exhibits performance qualities similar to the Fe-FER catalyst, indeed even slightly better.

### Example 4: Conversion of NOx and N₂O: Comparison of the Catalysts According to the Invention with the Prior Art

A catalytic test of reduction of nitrogen oxides (NOx) and dinitrogen oxide (N₂O) by ammonia (NH₃) in the presence of oxygen (O₂) is carried out at different operating temperatures for the catalysts synthesized according to example 1 (Fe-Nu-86) and example 2 (Fe-FER).

For the test of each sample, 200 mg of catalyst in powder form are placed in a quartz reactor. 145 L/h of a gas mixture having the following molar composition are fed into the reactor: 200 ppm NO, 50 ppm NO₂, 1000 ppm N₂O, 1250 ppm NH₃, 2.5% O₂, 8% H₂O, remainder N₂.

An FTIR analyzer is used to measure the concentration of the species NO, NO₂, NH₃, N₂O, CO, CO₂, H₂O, O₂ at the reactor outlet. The NOx conversions are calculated as follows:

$$NO x conversion = ( NO x inlet - NO x outlet ) / NO x inlet$$

$${N}_{2} O conversion = ( {N}_{2} O inlet - {N}_{2} O outlet ) / {N}_{2} O inlet$$

In these formulae, the inlet and outlet indices respectively indicate the content before and after catalytic reduction.

The NOx conversion results are presented in table 4 below:

TABLE 4

| | 300° C. | 400° C. | 450° C. | 500° C. | 600° C. |
|---|---|---|---|---|---|
| Fe-Nu-86 | 54% | 88% | 100% | 100% | 100% |
| Fe-FER | 58% | 92% | 100% | 100% | 100% |

The N₂O conversion results are presented in the table below:

TABLE 5

| | 300° C. | 400° C. | 450° C. | 500° C. | 600° C. |
|---|---|---|---|---|---|
| Fe-Nu-86 | 0% | 15% | 56% | 86% | 100% |
| Fe-FER | 0% | 5% | 35% | 80% | 97% |

The Fe-Nu-86 catalyst synthesized according to the invention provides deN₂O performance qualities superior to the Fe-FER catalyst with initiation at lower temperature. It also offers performance qualities very similar to the Fe-FER catalyst in terms of NOx conversion.

1. A process for preparing a catalyst comprising a zeolite of Nu-86 structural type and on iron, said process comprising at least the following steps:
i) mixing, in aqueous medium, of at least one source of silicon (Si) in SiO₂ oxide form, at least one source of aluminum (Al) in Al₂O₃ oxide form, a nitrogen-containing organic compound R, R being octamethonium bromide (OctBr₂), at least two sodium sources, one of these being sodium bromide (NaBr), the reaction mixture having the following molar composition:
SiO₂/Al₂O₃ of between 8 and 20,
H₂O/SiO₂ of between 15 and 60,
R/SiO₂ of between 0.05 and 0.35,
Na₂O/SiO₂ of between 0.05 and 0.3,
NaBr/SiO₂ of between 0.01 and 0.1, limits included,
step i) being conducted for a duration of between 5 and 15 minutes until a homogeneous mixture referred to as precursor gel is obtained;
ii) maturation of the precursor gel obtained at said step i) at a temperature of between 2° and 100° C., with or without stirring, for a duration of between 10 minutes and 48 hours, preferably between 18 and 24 hours;
iii) hydrothermal treatment of said precursor gel obtained at step ii) at a temperature of between 120° C. and 220° C., preferably between 14° and 195° C., for a duration of between 12 hours and 35 days, preferably between 12 hours and 33 days, until said Nu-86 zeolite forms;
iv) at least one ion exchange, comprising bringing said zeolite obtained at the preceding step into contact with a solution comprising at least one species capable of releasing iron, in solution in reactive form with stirring at a temperature between 2° and 95° C., preferably between 40 and 90° C., for a duration of between 1 hour and 2 days;
v) heat treatment by drying of the Nu-86 zeolite obtained on conclusion of the preceding step at a temperature of between 2° and 150° C. for a duration of between 2 and 24 hours followed by at least one calcination under a stream of air at a temperature of between 40° and 700° C. for a duration of between 2 and 20 hours.

2. The process as claimed in claim 1, wherein steps iv) and v) are inverted, and optionally repeated.

3. The preparation process as claimed in claim 2, wherein the Nu-86 zeolite obtained in step iii) directly undergoes a step v) of heat treatment, then at least one exchange of ions with an acid, or a compound such as ammonium chloride, sulfate or nitrate, in order to obtain a calcined Nu-86 zeolite in protonated form, before step iv) of ion exchange with iron.

4. The preparation process as claimed in claim 1 in which seed crystals of a zeolite of Nu-86 structural type are added to the reaction mixture of step i) in an amount of between 0.01% and 10% of the total mass of the sources of the tetravalent (Si) and trivalent (Al) elements in their oxide form (SiO₂ and Al₂O₃) in anhydrous form which are used in the reaction mixture, said seed crystals not being taken into account in the total mass of the sources of the tetravalent and trivalent elements.

5. The preparation process as claimed in claim 1, wherein the content of iron introduced by the ion exchange step iv) is between 0.5% and 6% by mass, preferably between 0.5% and 5% by mass, more preferably between 1% and 4% by mass, relative to the total mass of the anhydrous final catalyst.

6. A catalyst based on an Nu-86 zeolite and on iron for the decomposition of N₂O or the reduction of N₂O or the simultaneous reduction of NOx and of N₂O by a reducing agent such as NH₃ or H₂, which is capable of being obtained or directly obtained by the preparation process as claimed in claim 1.

7. The catalyst as claimed in claim 6, wherein the total content of iron is between 0.5% and 6% by mass, preferably between 0.5% and 5% by mass, more preferably between 1% and 4% by mass, relative to the total mass of the anhydrous final catalyst.

8. A process for the decomposition of N₂O or the reduction of N₂O or the simultaneous reduction of NOx and of N₂O by a reducing agent such as NH₃ or H₂, wherein the gas to be treated is brought into contact with a catalyst as claimed in claim 6.

9. The process for the decomposition of N₂O or the reduction of N₂O or the simultaneous reduction of NOx and of N₂O as claimed in claim 8, wherein said catalyst is formed by deposition in the form of a coating, on a honeycomb structure or a plate structure, or said catalyst is in the form of an extrudate or bead, containing up to 100% of said catalyst.

10. The process for the decomposition of N₂O or the reduction of N₂O or the simultaneous reduction of NOx and of N₂O as claimed in claim 9, wherein the honeycomb structure is formed by parallel channels which are open at both ends or comprises porous filtering walls in the case of which adjacent parallel channels are alternately blocked at either end of the channels.

11. The process for the decomposition of N₂O or the reduction of N₂O or the simultaneous reduction of NOx and of N₂O as claimed in claim 10, wherein the amount of catalyst deposited on said structure is between 50 to 250 g/L for the filtering structures and between 80 and 300 g/L for the structures with open channels.

12. The process for the decomposition of N₂O or the reduction of N₂O or the simultaneous reduction of NOx and of N₂O as claimed in claim 9, wherein the catalyst is combined with a binder such as ceria, zirconium oxide, alumina, non-zeolitic silica-alumina, titanium oxide, a mixed oxide of ceria-zirconia type, a tungsten oxide and/or a spinel in order to be formed by deposition in the form of a coating, it being possible preferably for said coating to be combined with another coating having the capacity to adsorb pollutants, in particular NOx, to reduce pollutants, in particular NOx, or promoting the oxidation of pollutants.

13. The process for the decomposition of N₂O or the reduction of N₂O or the simultaneous reduction of NOx and of N₂O as claimed in claim 8, wherein said catalyst is integrated:
into an exhaust line of an internal combustion engine running on carbon-based or non-carbon-based fuels, or
into a reactor for treating industrial flue gases.
